(19) United States
(12) Patent Application Publication
(10) Pub. No.: US 2004/0188193 A1
(43) Pub. Date: Sep. 30, 2004

(54) Motor back drive control for electric caliper brake system

(75) Inventors: Gary C. Fulks, Dayton, OH (US); Douglas E. Poole, Dayton, OH (US); Michael C. Pfeil, South Charleston, OH (US); John E. Pozenel, Dayton, OH (US); Timothy A. Haerr, Enon, OH (US)

Correspondence Address: SCOTT A. MCBAIN, DELPHI TECHNOLOGIES, INC., Legal Staff, Mail Code: 480-410-202, P.O. Box 5052, Troy, MI, 48098, US

(73) Assignee: DELPHI TECHNOLOGIES INC.

(21) Appl. No.: 10/397,505

(22) Filed: Mar. 26, 2003

(51) Int. Cl. F16D 65/36

(52) U.S. Cl. 188/156

(57) ABSTRACT

A method is directed to controlling an electric caliper brake system. The method provides for receiving an ignition voltage signal, receiving a caliper position signal, sending a motor shut down signal, sending a back drive control signal based on the received ignition voltage signal and the caliper position signal, and releasing stored energy from a non-linear device to a caliper brake system motor responsive to the back drive control signal. The non-linear device may be implemented as a capacitor. The step of sending a back drive control signal based on the received ignition voltage and the capacitor position signal includes analyzing the ignition voltage signal for an ignition voltage failure, analyzing the caliper position signal for caliper engagement, and transmitting the back drive control signal responsive to the ignition voltage failure and caliper engagement. Ignition voltage failure occurs when the ignition voltage signal is a low value.

### FIELD OF THE INVENTION

The technical field of this disclosure is brake systems, and more particularly, electric caliper brake system motor controllers.

### BACKGROUND OF THE INVENTION

Control of brake systems is an important aspect of automotive functionality. Brake systems must engage when required, such as, for example application of caliper pressure to slow or stop a vehicle. Additionally, brake systems must remain unengaged when not required. The vehicle function changes if brake systems, or portions of brake systems, engage when not required. Application of a portion of the brake system when not required can also change vehicle function as well. Fault mode effect analysis (FMEA) has resulted in a requirement to address primary system power failures in automobiles.

Typically, brake systems include some type of redundancy to reduce incidence of brake system control failure. Hydraulic brake systems typically utilize a matching of hydraulic calipers, such as, for example axel matching or diagonal matching. Axel matching includes utilizing the same brake controller to control both calipers on the same axel. In the event of a control system failure, both calipers on the axel (i.e. right and left) would apply and the vehicle would remain in control. Diagonal matching includes utilizing the same brake controller to control a diagonal pair of calipers. In the event of a control system failure, a caliper on each side of the vehicle (i.e. front right and rear left) would apply and the vehicle would remain in control. Additionally, in the event of an electrical power failure, hydraulic systems tend to not fail with the brake system applied. This is referred to as “fail off.”

Recently, hybrid brake systems have become increasingly utilized in the automotive industry. Hybrid systems typically utilize a hydraulic brake system for one axel (i.e. the front axel) and an electric or electro-mechanical brake system for the other axel. Additionally, electric or electro-mechanical only brake systems have become increasingly utilized in the automotive industry as well.

Typically, electric or electro-mechanical brake systems function independently. That is, there is a single brake system for each wheel in the system. Unfortunately, because of hybrid and electric/electro-mechanical systems independent functioning, vehicle control becomes problematic in the event of a brake system control system failure.

One such control system failure may occur when primary system power, such as ignition voltage, fails. In the event of a primary system power failure, electric/electro-mechanical systems may fail in a position whereby the braking system is applied. Back drive energy is viewed as an acceptable method for releasing the braking system. One system for providing back drive energy includes storage of the energy within internal or external dry cell batteries, such as, for example nickel cadmium or lithium batteries.

Unfortunately, these backup energy sources are not very robust and do not typically posses a long shelf life. Additionally, the expense included in routine replacement of dry cell energy sources is undesirable. It would be desirable, therefore, to provide a system that would overcome these and other disadvantages.

### SUMMARY OF THE INVENTION

One aspect of the invention provides a method for controlling an electric caliper brake system by receiving an ignition voltage signal, receiving a caliper position signal, sending a motor shut down signal, sending a back drive control signal based on the received ignition voltage signal and the caliper position signal, and releasing stored energy from a non-linear device to a caliper brake system motor responsive to the back drive control signal.

In accordance with another aspect of the invention, a computer readable medium storing a computer program includes: computer readable code for receiving an ignition voltage signal; computer readable code for receiving a caliper position signal; computer readable code for sending a motor shut down signal; and computer readable code for sending a back drive control signal based on the received ignition voltage signal and the caliper position signal.

In accordance with yet another aspect of the invention, a system for controlling a motor back drive control for an electric caliper brake system is provided. The system includes means for receiving an ignition voltage signal. The system further includes means for receiving a caliper position signal. The system additionally includes means for sending a motor shut down signal. Means for sending a back drive control signal based on the received ignition voltage signal and the caliper position signal is provided. Means for releasing stored energy from a non-linear device to a caliper brake system motor responsive to the back drive control signal is also provided.

The foregoing and other features and advantages of the invention will become further apparent from the following detailed description of the presently preferred embodiment, read in conjunction with the accompanying drawings. The scope of the invention is defined by the appended claims and equivalents thereof, the detailed description and drawings being merely illustrative of the invention rather than limiting the invention.

### BRIEF DESCRIPTION OF THE DRAWINGS

FIG. 1 is a schematic diagram illustrating a conventional electric caliper brake system control circuit;

FIG. 2 is a block diagram illustrating a motor back drive control circuit according to an embodiment of the present invention;

FIG. 3 is a schematic diagram illustrating a motor back drive control circuit according to an embodiment of the present invention; and

FIG. 4 is a flow diagram illustrating a method for controlling an electric caliper brake system control circuit according to an embodiment of the present invention.

Throughout the specification, and in the claims, the term “connected” means a direct connection between components or devices that are connected without any intermediate devices. The term “coupled” means either a direct connection between components or devices that are connected, or an indirect connection through one or more passive or active intermediary devices. The term “signal” means either a voltage or current signal.

### DETAILED DESCRIPTION OF THE PRESENTLY PREFERRED EMBODIMENT

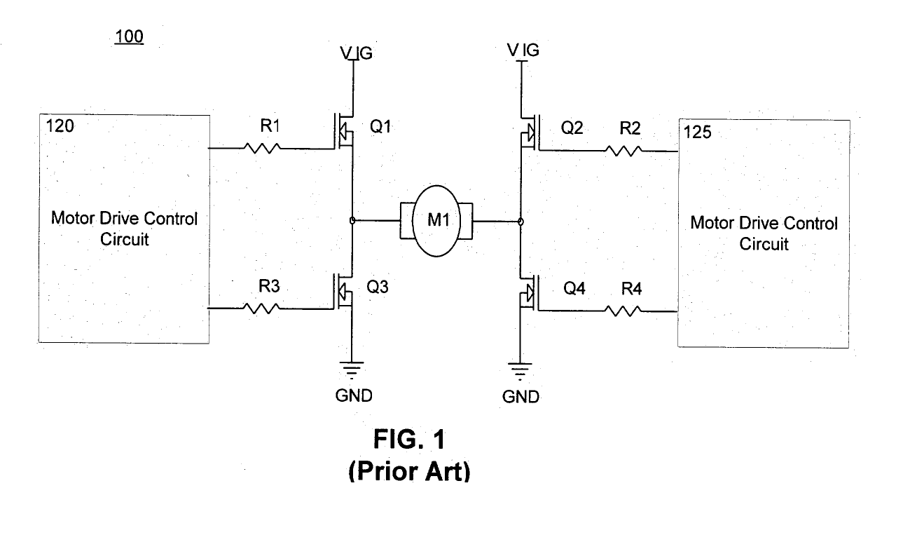

FIG. 1 is a schematic diagram illustrating a conventional electric caliper brake system control circuit 100. In FIG. 1, control circuit 100 includes a motor M1 having a first terminal coupled to transistors (Q1, Q3) and a second terminal coupled to transistors (Q2, Q4). The terminals of motor M1 are coupled to the source of each transistor (Q1, Q2) and the drain of each transistor (Q3, Q4). The drain of each transistor (Q1, Q2) is coupled to an ignition voltage source VIG. The source of each transistor (Q3, Q4) is coupled to ground. The gate of each transistor (Q1-Q4) is coupled to an associated motor drive control unit (120, 125) via a respective resistor (R1-R4). Control circuit 100 is arranged in an H-bridge configuration. Transistors (Q1-Q4) are referred to as drive transistors. Motor M1 is referred to as a brake motor.

In operation, each motor drive control unit (120, 125) controls a portion of the H-bridge configuration. For example, when a signal is received by control circuit 100 to apply a braking force, motor drive control unit 120 would turn on transistor Q1 and motor drive control unit 125 would turn on transistor Q4. Turning on transistors (Q1, Q4) would allow current to flow to motor M1 and turn on motor M1 thereby applying the required braking force.

Conversely, when a signal is received by control circuit 100 to release the brake force, motor drive control unit 125 would turn on transistor Q2 and motor drive control unit 120 would turn on transistor Q3. Turning on transistors (Q2, Q3) would allow current to flow from motor M1 and turn off motor M1 thereby releasing the force on the caliper.

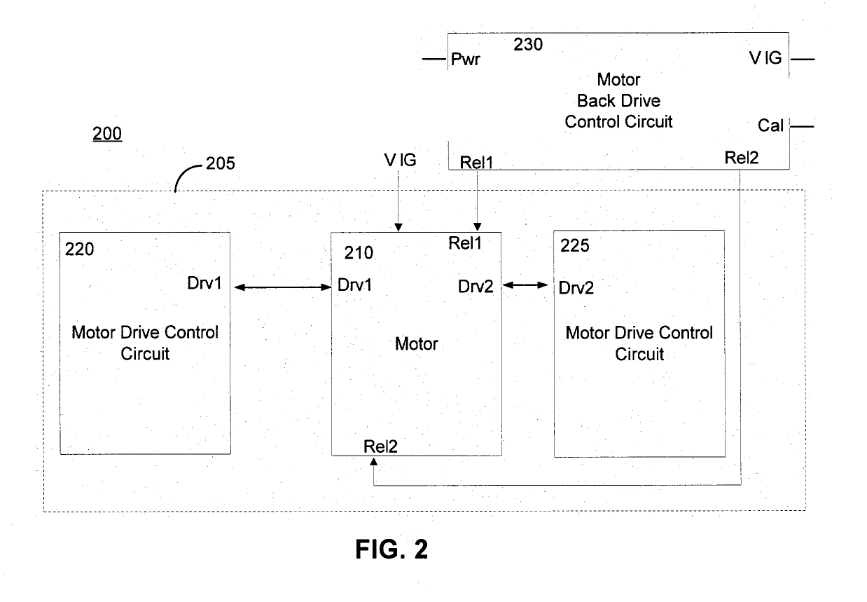

FIG. 2 is a block diagram illustrating an electric brake control circuit 200 according to an embodiment of the present invention. Electric brake control circuit 200 includes a brake system control circuit 205 and a motor back drive control circuit 230. Brake system control circuit 205 includes a motor 210 and motor drive control circuits (220, 225).

Motor 210 includes an ignition signal input terminal (VIG), first and second drive signal input terminals (Drv1, Drv2), and first and second release signal input terminals (Rel1, Rel2). Motor drive control circuit 220 includes a first drive signal output terminal Drv1. The first drive signal output terminal Drv1 of motor drive control circuit 220 is coupled to the first drive signal input terminal Drv1 of motor 210. Motor drive control circuit 225 includes a second drive signal output terminal Drv2. The second drive signal output terminal Drv2 of motor drive control circuit 225 is coupled to the second drive signal input terminal Drv2 of motor 210.

Motor back drive control circuit 230 includes a power signal input terminal (Pwr), an ignition signal input terminal (VIG), a caliper position input signal terminal (Cal), and first and second release signal output terminals (Rel1, Rel2). The first and second release signal output terminals (Rel1, Rel2) of motor back drive control circuit 230 are coupled to the first and second release signal input terminals (Rel1, Rel2) of motor 210.

In operation, brake system control circuit 205 functions similarly to brake system control circuit 100 detailed in FIG. 1 above. That is, motor drive control circuits (220, 225) produce drive signals responsive to demands made on the brake system by a user. Motor 210 receives the drive signals from motor drive control circuits (220, 225) and implements the user demands based on the received drive signals.

Simultaneous to the function of brake system control circuit 205, motor back drive control circuit 230 monitors the ignition signal input terminal (VIG) and the caliper position input signal terminal (Cal). When motor back drive control circuit 230 receives input signals consistent with predetermined requirements, motor back drive control circuit 230 produces a first release signal at first release signal output terminal Rel1 and a second release signal at second release signal output terminal Rel2.

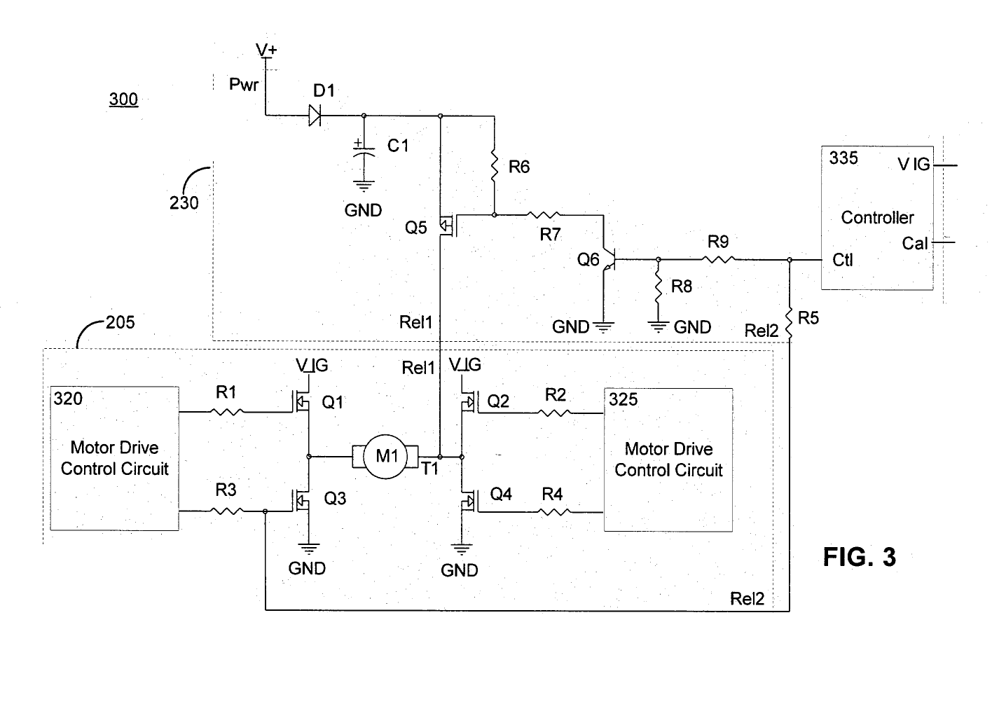

The first release signal is based on energy received from power signal input terminal (Pwr) and retained within motor back drive control circuit 230. Receipt and storage of energy within motor back drive control circuit 230 is detailed in FIG. 3 below.

FIG. 3 is a schematic diagram illustrating an electric brake control circuit 300 according to an embodiment of the present invention. Electric brake control circuit 300 includes a brake system control circuit 205 and a motor back drive control circuit 230. Brake system control circuit 205 is arranged in an H-bridge configuration and functions as detailed in FIGS. 1 and 2 above. In one embodiment, motor M1 is implemented as a brushless-type motor. In another embodiment, motor M1 is implemented as a brush-type motor.

Brake system control circuit 205 additionally includes a first release signal input terminal Rel1 and a second release signal input terminal Rel2. The first release signal input terminal Rel1 is coupled to a first motor terminal T1. The second release signal input terminal Rel2 is coupled to the gate of FET Q3.

Motor back drive control circuit 230 includes a controller 335 having an ignition signal input terminal (VIG), a caliper position input signal terminal (Cal), and a back drive control output signal terminal (Ctl). The back drive control output signal terminal (Ctl) is coupled to a first end of each resistor (R5, R9). Resistor R5 includes a second end coupled to the second release signal output terminal Rel2 of motor back drive control circuit 230.

Motor back drive control circuit 230 further includes a bi-polar junction transistor (BJT) Q6 having a base, a collector, and an emitter. In an example and referring to FIG. 3, BJT Q6 is configured as an npn BJT. The base of BJT Q6 is coupled to a second end of resistor R9 and to a first end of resistor R8. Resistor R8 includes a second end coupled to ground GND. The emitter of BJT Q6 is coupled to ground GND. The collector of BJT Q6 is coupled to a first end of resistor R7.

Motor back drive control circuit 230 additionally includes field effect transistor (FET) Q5 having a gate, a source, and a drain. In an example and referring to FIG. 3, FET Q5 is configured as a p-channel MOSFET. The gate of MOSFET Q5 is coupled to a second end of resistor R7 and to a first end of resistor R6. Resistor R6 includes a second end coupled to the source of MOSFET Q5. The source of MOSFET Q5 is additionally coupled to a first terminal of capacitor C1 and a cathode terminal of diode D1. Capacitor C1 includes a second terminal coupled to ground GND. Diode D1 additionally includes an anode terminal coupled to power signal input terminal (Pwr) of motor back drive control circuit 230. Capacitor C1 is arranged to receive energy from power signal input terminal (Pwr) via diode D1. Capacitor C1 is referred to as a back drive capacitor.

In another embodiment, diodes are located between the drain and the ignition voltage signal VIG of each FET (Q1 and Q2). In an example, the diodes are implemented as an MBR1645CT available from ON Semiconductor of Phoenix, Ariz.

In one embodiment and referring to FIG. 3, FETs Q1-Q4 are implemented as n-channel MOSFETS, such as, for example an IRL1404 available from International Rectifier of El Segundo, Calif. In this embodiment, resistors R1-R4 are implemented as 22Ω resistors. FET Q5 is implemented as a p-channel MOSFET, such as, for example an IRF4905 available from International Rectifier of El Segundo, Calif. BJT Q6 is implemented as an npn BJT, such as, for example a 2N3904 available from ON Semiconductor of Phoenix, Ariz. Resistors R5, R7, and R8 are implemented as 10 kΩ resistors. Resistor R6 is implemented as a 100 kΩ resistor and resistor R9 is implemented as a 560Ω resistor. Capacitor C1 is implemented as a 2200 μF capacitor and diode D1 in implemented as an MBR340 available from ON Semiconductor of Phoenix, Ariz.

In operation and according to one embodiment, controller 335 receives signals from the ignition signal input terminal (VIG) and the caliper position input signal terminal (Cal). When controller 335 receives input signals consistent with predetermined requirements, controller 335 produces a back drive control signal at back drive control output signal terminal (Ctl).

In another embodiment, a processor (not shown) receives the ignition signal and the caliper position signal, and provides a control signal to controller 335. In this embodiment, when controller 335 receives the control signal the controller 335 produces a back drive control signal at back drive control output signal terminal (Ctl).

The back drive control signal is received at the base of BJT Q6 and causes BJT Q6 to “forward bias.” When BJT Q6 forward biases, MOSFET Q5 “turns on.” When MOSFET Q5 turns on, energy accumulated in capacitor is released to first release signal output terminal Rel1 as a first release signal. Additionally, the back drive control signal is received at the second release signal output terminal Rel2 as a second release signal.

The first release signal is transmitted to first release signal input terminal Rel1 of brake system control circuit 205 from first release signal output terminal Rel1 of motor back drive control circuit 230. The second release signal is transmitted to second release signal input terminal Rel2 of brake system control circuit 205 from second release signal output terminal Rel2 of motor back drive control circuit 230.

The first release signal is transmitted to motor terminal T1 from first release signal input terminal Rel1. The first release signal includes a majority of the stored energy contained within capacitor C1. The energy within the first release signal is applied to the motor and interrupts functioning of the motor. In one embodiment, the first release signal interrupts functioning of the motor by providing energy to back drive the motor.

The second release signal is transmitted to the gate of FET Q3. The second release signal is applied to FET Q3 and deactivates the motor. In one embodiment, the second release signal deactivates the motor by completing the current path to back drive the motor.

In these embodiments, power is supplied to the power signal input terminal (Pwr) in the form of a voltage at a voltage level of 24V. The voltage level supplied to the power signal input terminal (Pwr) must be significantly greater than the brake system control circuit 205 operating voltage to allow the released energy to back drive motor M1. Since energy stored within a capacitor can be expressed as follows:

E=½ CV2

Solving the energy equation results in an available energy of 0.634 J within the specified capacitor and with the specified voltage applied. In this embodiment, the electric brake control circuit 300 yields a time delay (T=RC), utilizing a motor resistance of 0.6Ω, of 1.32 mS before the motor function of motor M1 is interrupted.

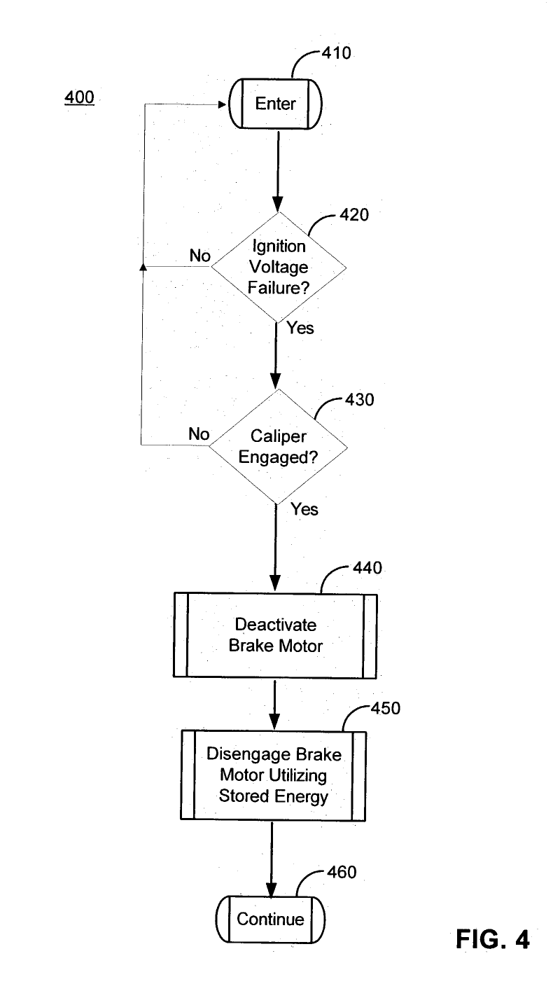

FIG. 4 is a flow diagram illustrating a method 400 for controlling an electric caliper brake system control circuit according to an embodiment of the present invention. Method 400 may utilize one or more systems detailed in FIGS. 2 and 3, above.

Method 400 begins at block 410 where a need for controlling an electric caliper brake system is established. In one embodiment, a need to control the electric caliper brake system occurs when the electric caliper brake system is activated. Method 400 then advances to decision block 420.

At decision block 420, an ignition voltage signal is received. If the received ignition voltage signal indicates an ignition voltage failure, method 400 advances to decision block 430. If the received ignition voltage signal does not indicate an ignition voltage failure, method 400 returns to entry block 410. In one embodiment, an ignition voltage failure occurs when the ignition voltage signal is a low value, such as, for example 6V in a 12V system.

At decision block 430, a caliper position signal is received. If the received caliper position signal indicates an engaged caliper, method 400 advances to block 440. If the received caliper position signal does not indicate an engaged caliper, method 400 returns to entry block 410. In one embodiment, the caliper position signal is a measure of clamping force currently applied by the caliper. In another embodiment, a caliper is considered engaged when the caliper is engaged with a disk portion of the caliper brake system.

At block 440, motor M1 is deactivated. In one embodiment and referring to FIGS. 1 and 3, motor M1 is deactivated when brake system control circuit 205 receives a motor shut down signal. In an example and referring to FIG. 1, the received motor shut down signal instructs motor drive control circuits (320, 325) to turn off the H-bridge drive transistors (Q1-Q4). In this embodiment, when the H-bridge drive transistors (Q1-Q4) are turned off motor M1 is deactivated. Unfortunately, when motor M1 is deactivated the caliper and therefore the motor M1 may remain engaged. Method 400 then advances to block 450

At block 450, motor M1 is disengaged utilizing stored energy. In one embodiment and referring to FIG. 3, brake motor M1 is disengaged utilizing stored energy coupled from a non-linear device, such as, for example a capacitor. The stored energy is released based on input signals consistent with predetermined requirements, such as, for example an ignition voltage signal and a caliper position signal.

In one embodiment and referring to FIGS. 2 and 3, a back drive control signal is produced by controller 335 based on the received ignition voltage signal and the caliper position signal. In an example, controller 335 is implemented as a processor. In another example, controller 335 is implemented as a portion of a processor. In yet another example, controller 335 is implemented as a standard controller.

In another embodiment and referring to FIG. 3, a back drive control signal is produced by controller 335 based on a control signal received from a processor (not shown). In this embodiment, the processor (not shown) would receive the ignition voltage signal and the caliper position signal and produce the control signal based on the received ignition voltage signal and the received caliper position signal.

In another embodiment and referring to FIG. 3, the back drive control signal includes a first release signal and a second release signal. The first release signal includes a majority of stored energy within capacitor C1. The first release signal is transmitted to the motor M1 to interrupt motor functionality. In this embodiment, a second release signal is transmitted to the motor to complete the current path to back drive the motor, thereby allowing disengagement of the motor. Method 400 advances to block 460 where the method ends.

The above-described method of controlling an electric caliper brake system is an example method. The method of controlling an electric caliper brake system illustrates one possible approach for controlling an electric caliper brake system. The actual implementation may vary from the electronic package discussed. Moreover, various other improvements and modifications to this invention may occur to those skilled in the art, and those improvements and modifications will fall within the scope of this invention as set forth in the claims below.

The present invention may be embodied in other specific forms without departing from its essential characteristics. The described embodiments are to be considered in all respects only as illustrative and not restrictive.

What is claimed is:

1. A method of controlling an electric caliper brake system, the method comprising:
receiving an ignition voltage signal;
receiving a caliper position signal;
sending a motor shut down signal;
sending a back drive control signal based on the received ignition voltage signal and the caliper position signal; and
releasing stored energy from a non-linear device to a caliper brake system motor responsive to the back drive control signal.

2. The method of claim 1, further comprising:
replacing the stored energy.

3. The method of claim 1, wherein sending a back drive control signal based on the received ignition voltage and the capacitor position signal comprises:
analyzing the ignition voltage signal for an ignition voltage failure;
analyzing the caliper position signal for caliper engagement; and
transmitting the back drive control signal responsive to the ignition voltage failure and caliper engagement.

4. The method of claim 3, wherein ignition voltage failure occurs when the ignition voltage signal is a low value.

5. The method of claim 3, wherein caliper engagement occurs when the caliper is engaged with a disk portion of the caliper brake system.

6. The method of claim 5, wherein the non-linear device is a capacitor

7. The method of claim 1, wherein a processor receives the signals and sends the back drive control signal.

8. The method of claim 1, wherein releasing stored energy from a non-linear device to a caliper brake system motor responsive to the back drive control signal comprises:
transmitting a first release signal to the motor, the first release signal including a majority of the stored energy;
applying energy within the first release signal to the motor,
interrupting motor function of the motor responsive to the applied energy;
transmitting a second release signal to the motor,
applying energy within the second release signal to the motor, and
disengaging the motor responsive to the applied energy.

9. The method of claim 1, wherein the motor is selected from the group consisting of: a brushless type motor and a brush type motor.

10. A computer readable medium storing a computer program comprising:
computer readable code for receiving an ignition voltage signal;
computer readable code for receiving a caliper position signal;
computer readable code for sending a motor shut down signal; and
computer readable code for sending a back drive control signal based on the received ignition voltage signal and the caliper position signal.

11. The computer readable medium of claim 10, further comprising:
computer readable code for sending a stored energy recovery signal.

12. The computer readable medium of claim 10, wherein the computer readable code for sending the back drive control signal based on the received ignition voltage signal and the caliper position signal comprises:
computer readable code for analyzing the ignition voltage signal for an ignition voltage failure;
computer readable code for analyzing the caliper position signal for caliper engagement; and
computer readable code for transmitting the back drive control signal responsive to the ignition voltage failure and caliper engagement.

13. The computer readable medium of claim 12, wherein ignition voltage failure occurs when the ignition voltage signal includes is a low value.

14. The computer readable medium of claim 12, wherein caliper engagement occurs when the caliper is engaged with a disk portion of the caliper brake system.

15. The computer readable medium of claim 10, wherein the back drive control signal causes a release of stored energy from a non-linear device to a caliper brake system motor.

16. The computer readable medium of claim 15, wherein the non-linear device is a capacitor.

17. The computer readable medium of claim 15, wherein the back drive control signal comprises:
a first release signal, the first release signal including a majority of the stored energy and designed to interrupt motor function; and
a second signal, the second release signal designed to disengage the motor.

18. The computer readable medium of claim 10, wherein a processor receives the signals and sends the back drive control signal.

19. The computer readable medium of claim 10, wherein the motor is selected the group consisting of: a brushless type motor and a brush type motor.

20. A system for controlling a motor back drive control for an electric caliper brake system, the system comprising:
means for receiving an ignition voltage signal;
means for receiving a caliper position signal;
means for sending a motor shut down signal;
means for sending a back drive control signal based on the received ignition voltage signal and the caliper position signal; and
means for releasing stored energy from a non-linear device to a caliper brake system motor responsive to the back drive control signal.
